(19) United States
(12) Patent Application Publication
(10) Pub. No.: US 2024/0192680 A1
(43) Pub. Date: Jun. 13, 2024

(54) DECENTRALIZED ON-DEMAND REMOTE OPERATOR AND DRIVER SERVICE

(71) Applicant: TOYOTA MOTOR ENGINEERING & MANUFACTURING NORTH AMERICA, INC., Plano, TX (US)

(72) Inventors: Rohit Gupta, Santa Clara, CA (US); Nejib Ammar, San Jose, CA (US); Akila C. Ganlath, San Jose, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/072,523

(22) Filed: Nov. 30, 2022

(51) Int. Cl. G05D 1/00; B60W 60/00; G06Q 10/0631

(52) U.S. Cl. CPC G05D 1/0011; B60W 60/0015; G06Q 10/063112; G06Q 10/063116; B60W 2420/54; B60W 2540/215; B60W 2540/22; B60W 2540/30; B60W 2556/45

(57) ABSTRACT

Systems and methods are provided for programmatically determining a remote operator of an autonomous or semi-autonomous vehicle. For example, some implementations may relate to assigning and reassigning a remote operator user in accordance with real-time changes in environmental characteristics of the distributed network of vehicles, remote operators, and (potentially) drivers.

### TECHNICAL FIELD

The present disclosure relates generally to programmatically determining a remote operator of an autonomous or semi-autonomous vehicle, and in particular, some implementations may relate to assigning and reassigning remote operators in accordance with real-time changes in environmental characteristics of the distributed network of vehicles, remote operators, and (potentially) drivers.

### DESCRIPTION OF RELATED ART

An autonomous vehicle is capable of sensing its environment and operating without human involvement. For example, the vehicle does not need a human passenger to take control of the vehicle at any time, nor is a human passenger required to be present in the vehicle at all. The autonomous vehicle can theoretically operate on any street that a traditional vehicle can operate and perform standard operations that an experienced human driver would perform.

### BRIEF SUMMARY OF THE DISCLOSURE

Different levels of driving automation exist, ranging from Level 0 (fully manual) to Level 5 (fully autonomous). There are also instances where the vehicle can operate in a difficult situation and humans monitoring the vehicle may not fully trust the vehicle to make the correct operational decisions. Better systems are needed.

According to various embodiments of the disclosed technology, human operators may assist semi-autonomous or fully autonomous vehicles temporarily and remotely from the vehicle during operation of the vehicle. In these systems, the teleoperated driving or remote-controlled driving can utilize the human operator that is remote from the vehicle to operate the vehicle. The human operator that is remote, or a “remote operator,” may be located in a room some distance away from the vehicle (e.g., the distance being greater than a threshold distance away from the vehicle, like 5-100 miles). The room may include a steering wheel, brake pedal, and gas pedal, for example, and the remote operator can remotely operate the vehicle. The remote operator may view the environment of the vehicle on a display consisting of one or more monitors placed in front of the remote operator. Using the remote operator, the autonomous vehicles can operate without anyone inside the vehicle performing the driving operations, or the remote operator may be ready to assist the driver of a semi-autonomous vehicle with a limited driving situation from afar.

In the systems, the remote operator may be assigned a cluster of vehicles to monitor concurrently. The system can receive a help request to assist one vehicle in the cluster of vehicles, and the remote operator can turn their attention to that vehicle. However, the other vehicles in the cluster may remain unmonitored while the remote operator is temporarily assisting the vehicle associated with the help request. While the single vehicle needs additional direction and attention, the remote operator may be incapable of operating multiple vehicles simultaneously and remotely, which can lead the other vehicles in the cluster to be unmonitored.

Some embodiments described herein are directed to programmatically matching a remote operator with a driver profile or environmental conditions of the vehicle. The vehicle may be added to the cluster of vehicles that the remote operator is monitoring. Once the vehicle needs more help (e.g., in association with a request for help or other identified issue), the decentralized system may reassign the other vehicles monitored by the remote operator, on-demand, in accordance with a recalculated priority of the next best remote operator.

In being decentralized, multiple locations of remote operators may be implemented with the disclosed system. For example, the decentralized system can be deployed in Las Vegas or a sub-sector of Las Vegas (e.g., like a particular neighborhood or along a particular street) to monitor vehicles in that smaller area, as compared to a centralized system that may be responsible for the state of Nevada or even the USA. The speed of the data transmissions between the vehicles and the decentralized centers, as well as the remote operator instructions, may be faster than the centralized location. In some cases, the computational power needed to implement the decentralized system with multiple remote operators and clusters is much lower and the performance output may be higher than these centralized systems as well.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example vehicle architecture for implementing a decentralized on-demand remote operator and driver service in accordance with one embodiment of the systems and methods described herein.

FIG. 3 illustrates an example backend or cloud-based matching system for implementing a decentralized on-demand remote operator and driver service in accordance with one embodiment of the systems and methods described herein.

FIG. 4 illustrates an initial assignment of a plurality of remote operators and vehicles in accordance with one embodiment of the systems and methods described herein.

FIG. 5 illustrates a clustering of help requests by request characteristic in accordance with one embodiment of the systems and methods described herein.

FIG. 6 illustrates an assignment of a cluster of help requests in accordance with one embodiment of the systems and methods described herein.

FIG. 7 is an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can provide a programmatic assignment and reassignment of remote operators for an autonomous or semi-autonomous vehicle. The remote operator may correspond with the profile that can be matched with a driver profile or environmental conditions of the vehicle. The vehicle may be added to a cluster of vehicles that the remote operator is monitoring. Once the vehicle needs more help (e.g., in association with a request for help or other identified issue), the system may reassign the other vehicles monitored by the remote operator in accordance with a recalculated priority of the next best remote operator. The next best remote operator can monitor or directly interact with the reassigned vehicles while the original remote operator can continue to interact with the vehicle that needs more help.

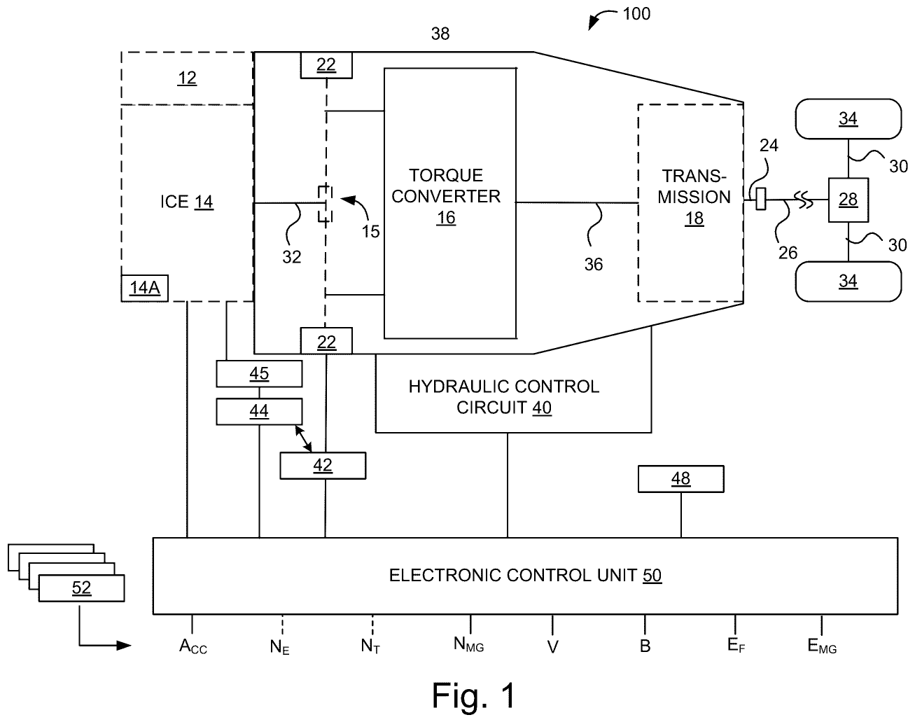

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for programmatic assignment and reassignment of remote operators for an autonomous or semi-autonomous vehicles can be implemented in other types of vehicle including gasoline- or diesel-powered vehicles, fuel-cell vehicles, electric vehicles, or other vehicles. Any of these vehicles may be implemented as an autonomous or semi-autonomous vehicle.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 100 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 100 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 100 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move vehicle 100 and adjust vehicle speed. Motor 22 can also function as a generator to generate electrical power such as, for example, when coasting or braking. Battery 44 may also be used to power other electrical or electronic systems in vehicle 100. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of vehicle 100 as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of vehicle 100. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in vehicle 100. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

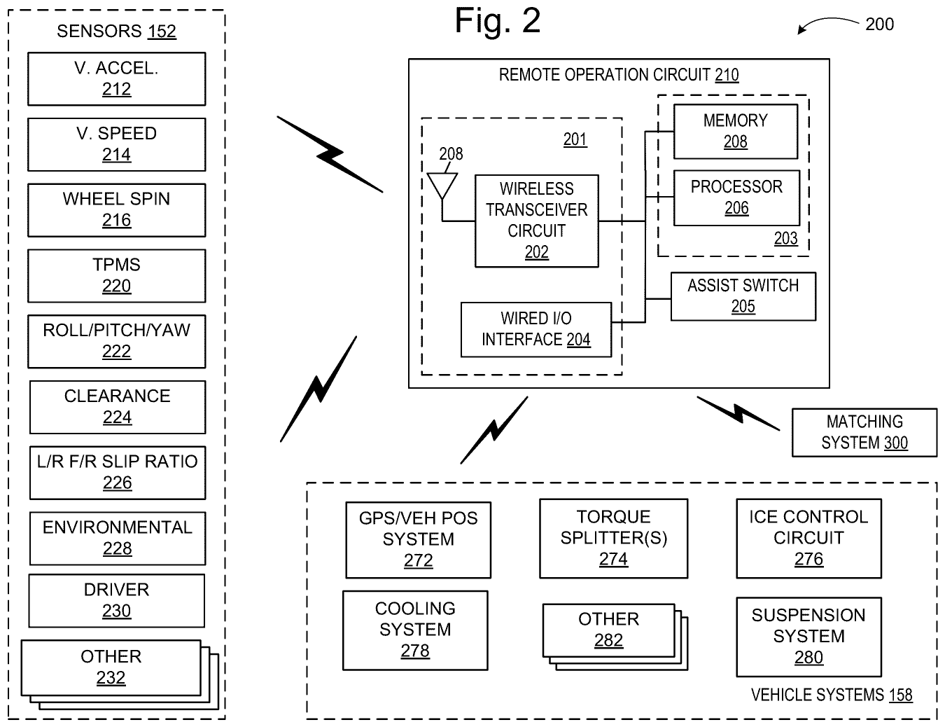

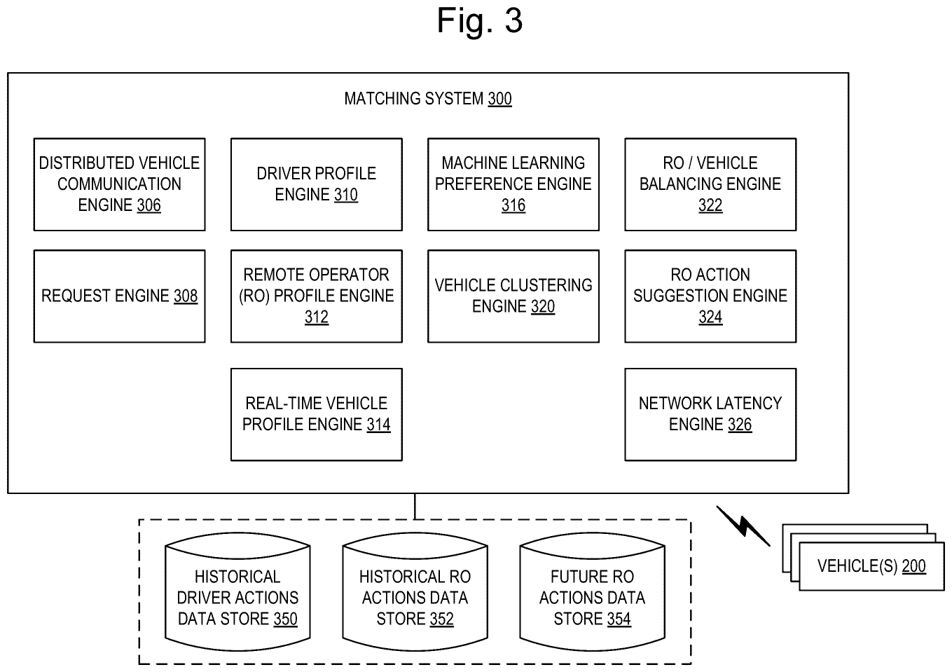

FIG. 2 illustrates an example vehicle architecture for implementing a decentralized on-demand remote operator and driver service in accordance with one embodiment of the systems and methods described herein. In this example, vehicle 200 includes remote operation circuit 210, sensors 152, and vehicle systems 158, in addition to or in replacement of other physical components illustrated in vehicle 100 of FIG. 1. Any of these components illustrated in FIG. 2 may electronically communicate with matching system 300, which is further described with FIG. 3.

Sensors 152 and vehicle systems 158 can communicate with remote operation circuit 210 via a wired or wireless communication interface. Although sensors 152 and vehicle systems 158 are depicted as communicating with remote operation circuit 210, they can also communicate with each other as well as with other vehicle systems. Remote operation circuit 210 can be implemented as an ECU or as part of an ECU such as, for example electronic control unit 50 in FIG. 1. In other embodiments, remote operation circuit 210 can be implemented independently of the ECU.

Remote operation circuit 210 in this example includes communication circuit 201, decision circuit 203 (including processor 206 and memory 208), assist switch 205, and power supply (not shown). Components of remote operation circuit 210 are illustrated as communicating with each other via a data bus, although other communication interfaces can be included. Manual assist switch 205 that can be operated by the user to manually select the autonomous driving mode or manual driving mode.

Processor 206 can include one or more GPUs, CPUs, microprocessors, or any other suitable processing system. Processor 206 may include a single core or multicore processors. Memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by processor 206 to execute via remote operation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a remote operation circuit 210.

Communication circuit 201 either or both a wireless transceiver circuit 202 with antenna 208 and a wired I/O interface 204 with an associated hardwired data port (not illustrated). As this example illustrates, communications with remote operation circuit 210 can include either or both wired and wireless communications circuits 201. Wireless transceiver circuit 202 can include a transmitter and a receiver (not shown) to allow wireless communications via any of a number of communication protocols such as, for example, Wi-Fi®, Bluetooth®, near field communications (NFC), Zigbee®, and any of a number of other wireless communication protocols whether standardized, proprietary, open, point-to-point, networked or otherwise. Antenna 208 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by remote operation circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

The power supply (incorporated with any of the features herein) can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 100, with which vehicle 200 is implemented. In the illustrated example, sensors 152 include vehicle acceleration sensors 212, vehicle speed sensors 214, wheelspin sensors 216 (e.g., one for each wheel), tire pressure monitoring system (TPMS) 220, accelerometers such as 3-axis accelerometer 222 to detect roll, pitch and yaw of the vehicle, vehicle clearance sensors 224, left-right and front-rear slip ratio sensors 226, environmental sensors 228 (e.g., to detect salinity or other environmental conditions), and driver sensors 230. Additional sensors 232 can also be included as may be appropriate for a given implementation of vehicle 200.

In some examples, driver sensors 230 may detect driver data. For example, sensors may be placed in the steering wheel, vehicle driver seat, vehicle passenger seat, rear-view mirror, temperature control, worn by the driver itself, or placed around other locations of vehicle 100 to help determine driver data. The driver data may comprise for example, audio data, heartbeat, or other physical measurements that may be analyzed in order to help determine the physical or emotional state of the driver. These and other sensors are provided for illustrative purposes and should not be limiting to the disclosure.

In some examples, driver sensors 230 may comprise a wearable device or may be in communication with a wearable device to collect health data for the driver or other occupant of the vehicle. The health data may be collected directly from the wearable device or may be collected from a portable computing device that includes a sensor, which is in communication with the wearable device. Driver sensors 230 may include any health sensors, for example including heart rate monitors, step counters, and the like. Driver sensors 230 may collect health data from a wearer of the wearable device and include a transmitter to send the collected health data to the vehicle, either directly or via the portable computing device.

In some examples, driver sensors 230 may comprise a microphone to collect audio data for the driver or other occupant of the vehicle. The audio data may be compared with a threshold value to determine whether the driver is under stress. For example, a Fourier transform may be applied in the frequency domain of the audio data and compared with sinusoids of various frequencies to obtain a magnitude coefficient. If the coefficient is large in comparison to a coefficient threshold, there may be a high similarity between the audio data and the sinusoid to a predetermined stress level. When the coefficient is small in comparison to the coefficient threshold, there may be little to no similarity between the audio data and the sinusoid, which can identify that the periodic oscillation is present at a different frequency and the audio data is not under stress (e.g., not similar to the predetermined high stress level values).

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

During operation, remote operation circuit 210 can receive information from various vehicle sensors to determine whether a remote operator should be ready to operate the vehicle by performing the driving operations, or be ready to assist the driver of a semi-autonomous vehicle with a limited driving situation from afar. Also, the driver may manually activate the assist mode by operating assist switch 205. Communication circuit 201 can be used to transmit and receive information between remote operation circuit 210 and sensors 152, and remote operation circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that are used in determining whether to activate the assist mode or communicate with matching system 300, as described with FIG. 3. Additionally, communication circuit 201 can be used to send an activation signal or other activation information to various vehicle systems 158 as part of entering the assist mode. For example, as described in more detail below, communication circuit 201 can be used to send signals to one or more of: torque splitters 274 to control front/rear torque split and left/right torque split; motor controllers 276 to, for example, control motor torque, motor speed of the various motors in the system; ICE control circuit 276 to, for example, control power to engine 14 (e.g., to shut down the engine so all power goes to the rear motors, to ensure the engine is running to charge the batteries or allow more power to flow to the motors); cooling system 278 (e.g., to increase cooling system flow for one or more motors and their associated electronics); or suspension system 280 (e.g., to increase ground clearance such as by increasing the ride height using the air suspension). The decision regarding what action to take via these various vehicle systems 158 can be made based on the information detected by sensors 152. Examples of this are described in more detail below.

FIG. 3 illustrates an example backend or cloud-based matching system for implementing a decentralized on-demand remote operator and driver service in accordance with one embodiment of the systems and methods described herein. Matching system 300 is configured to match, reassign, and optimize the assignment of remote operators with vehicles based on various factors described herein, including transmitting communications to and from the vehicles themselves. Matching system 300 may comprise various components similar to the components illustrated in FIG. 2, including a processor, memory, power supply, data bus, and the like.

Matching system 300 comprises various components and engine in communication with one or more data stores. The components and engines may execute machine readable instructions to perform the processes described herein. The components and engines may comprise, for example, distributed vehicle communication engine 306, request engine 308, driver profile engine 310, remote operator (RO) profile engine 312, real-time vehicle profile engine 314, machine learning preference engine 316, vehicle clustering engine 320, RO/vehicle balancing engine 322, remote operator action suggestion engine 324, and network latency engine 326. Each of these components and engines may write or store data in various data stores, including historical driver actions data store 350, historical remote operator actions data store 352, and future remote operator actions data store 354.

Distributed vehicle communication engine 306 is configured to identify various vehicles through established communications systems (e.g., Vehicle-to-Infrastructure (V2I) Resources or Vehicle-to-Vehicle Communication (V2V), etc.). Each vehicle may correspond with a unique identifier that may be selected and used to establish a communication channel between a remote operator and the vehicle (e.g., vehicle 200).

Request engine 308 is configured to generate, send, and receive a help request for the vehicle. The help request may be generated from a manual or automated process. For example, the driver of the vehicle may manually-activate a switch at the vehicle (e.g., assist switch 205 of FIG. 2), which can trigger the generation of the help request by request engine 308. In another example, the help request may be generated by an automated help request determined by the vehicle (e.g., identifying an emergency event from sensor data, like a roll of the vehicle by sensor 222, wheel slippage by sensor 226, or driver sensor 230). In another example, the help request may be generated remotely from the vehicle in association with an emergency event, including by the remote operator manually identifying the emergency event or by an automated process determining the emergency event (e.g., using V2I technology).

Driver profile engine 310 is configured to determine a driver profile. For example, actions of a driver of the vehicle may be stored in historical driver actions data store 350 and analyzed by driver profile engine 310 to identify propensities of the driver (e.g., commonly decreases speed at a yellow light or low stress levels on a Saturday morning, commonly drives in City A or around Main Street, etc.) or preferences of the driver (e.g., prefers remote operates that are located around the home of the driver not more than 50 miles away, etc.). In some examples, the driver profile may comprise various characteristics identified by the driver (e.g., in response to a questionnaire or other question and answer process).

Remote operator (RO) profile engine 312 is configured to determine a remote operator profile of a remote operator. The remote operator profile may comprise various characteristics, including a location characteristic (e.g., where the remote operator has knowledge of the geographic location), a mitigation characteristic (e.g., corresponding with the emergency event), and speech characteristic. In some examples, the remote operator profile may comprise various characteristics identified by the remote operator (e.g., in response to a questionnaire or other question and answer process).

Real-time vehicle profile engine 314 is configured to determine a real-time characteristic of the vehicle. The real-time characteristic may comprise, for example, a geographic location (e.g., determined by GNSS), speed (e.g., determined through vehicle sensors 152), an emergency event (e.g., from sensor data, like a roll of the vehicle by sensor 222 or wheel slippage by sensor 226, driver sensor 230, or a manual or automated identification), or other features associated with the vehicle that occur in real-time.

Machine learning preference engine 316 is configured to match the remote operator with the appropriate vehicle at a point of time, resulting in a cluster of vehicles being assigned to a particular remote operator. The matching may identify the cost of items Oro and future help requests Wᵣₒ for one or more remote operators in association with the following formula:

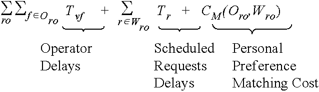

The objective may attempt to fulfill as many help requests as possible, while reducing delays and matching personal preference costs of all users. The delay may correspond with the sum of waiting time and operatory delay due to the availability and readiness of the remote operators. The constraint for items “i” may correspond with the following formula:

tᵢ^{pickup}−tᵢ^{req}≤Tᵢ^{max wait},tᵢ^{sch_avl}−tᵢ^{exp,avl}≤Tᵢ^{max travel}

Machine learning preference engine 316 is also configured to match characteristics, propensities, and preferences in profiles with each other, including remote operator profiles with driver profiles, and vice versa. For example, a characteristic of a remote operator profile of a remote operator may match a characteristic of the driver profile. The remote operator and the driver may be matched and the vehicle of the driver may potentially be added to the cluster of the remote operator.

In some examples, machine learning preference engine 316 may reassign the other vehicles monitored by the remote operator in accordance with a recalculated priority of the next best remote operator. The recalculated priority may receive a help request to assign a remote operator, which can be initially associated with multiple remote operators (e.g., prior to assigning the help request to the multiple remote operators). The help request may be encoded as a help request k-times (e.g., k+1-size trip feature). The encoded help request may be converted as a vector of numbers into a vector of probabilities, where the probabilities of each value are proportional to the relative scale of each value in the vector. This collection of probabilities may help determine an assignment for the help request to the remote operator with the highest probability.

Vehicle clustering engine 320 is configured to group help requests by similarities into clusters. Once the help requests are grouped as clusters, the individual clusters may be assigned to the remote operator. In some examples, a help request may be added or removed from an existing cluster assigned to a remote operator, as described herein. In some examples, the clustering process may be implemented as a multi-objective optimization problem that identifies distance calculations between profile characteristics of the driver and real-time characteristics of the vehicle. The clustering process may iteratively add and remove help request nodes from each cluster as more information is received.

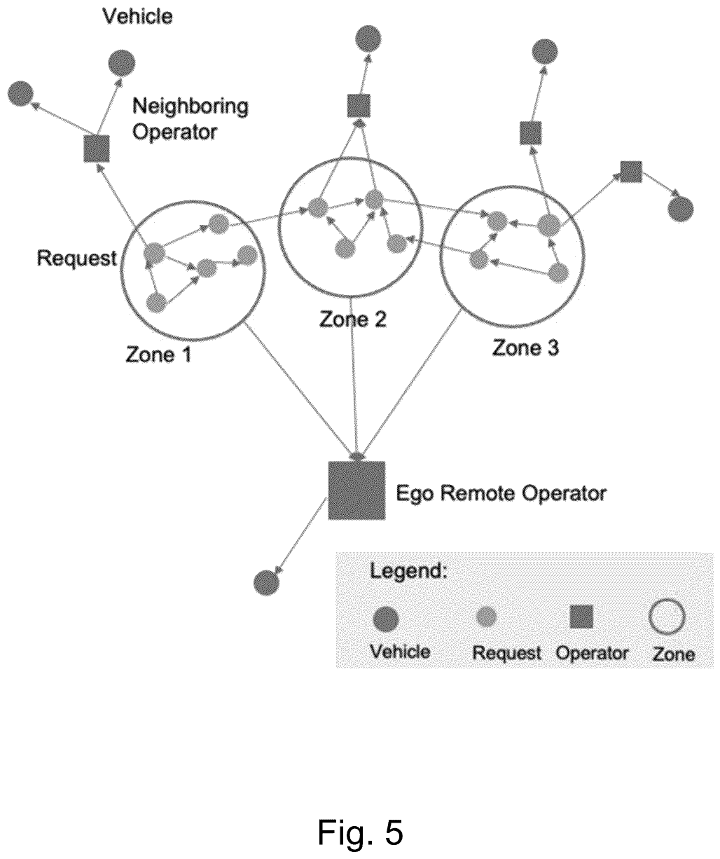

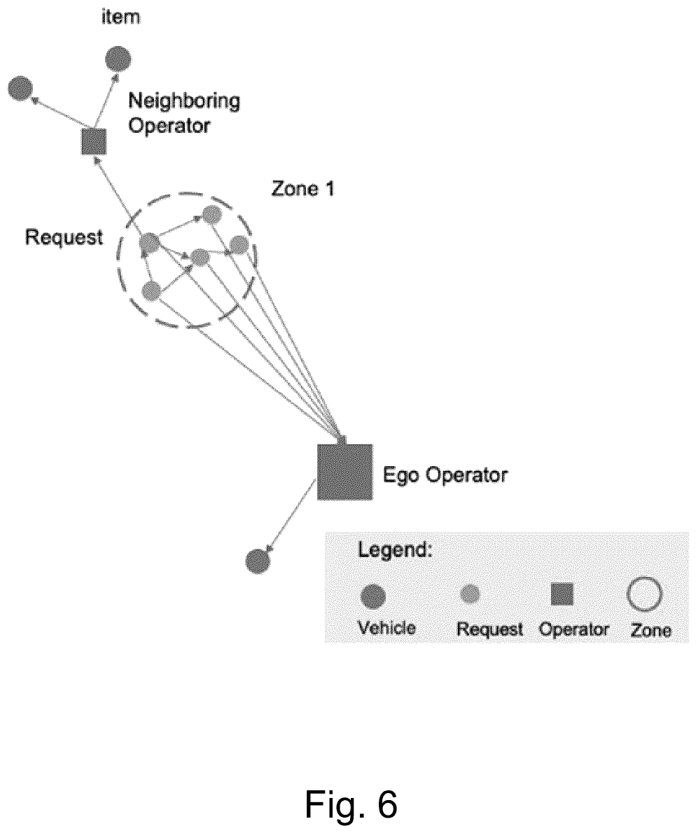

In FIG. 5, the help requests are shown clustered in zones. Vehicle clustering engine 320 may identify which zone to assign to the particular remote operator. In some examples, the three zones illustrated in FIG. 5 may be assigned to a single machine in a distributed implementation of matching system 300. The remote operator associated with the machine may have the ability to select one or more of the zones of clustered requests that are available at that geographic location. The selection of the zone by the remote operator is illustrated in FIG. 6, where the other zones associated with other clusters of help requests may be reassigned to other remote operators.

RO/vehicle balancing engine 322 is configured to assign a remote operator with drivers or vehicles as a cluster maintained by the remote operator. RO/vehicle balancing engine 322 may work as a decentralized algorithm (e.g., associated with a decentralized system of remote operators) suitable for remote operator/driver and vehicle supply demand system. The decentralized remote operator sharing problem may be implemented as a multi-agent reinforcement learning problem, using graph attention networks or graph neural network (GNN) model to build a hierarchical structure of remote operators. The hierarchical structure can be generalized to different decision spaces and handle real-world remote operator handling problems where a plurality of user help requests can be associated with each remote operator (e.g., tens or hundreds of user help requests, etc.).

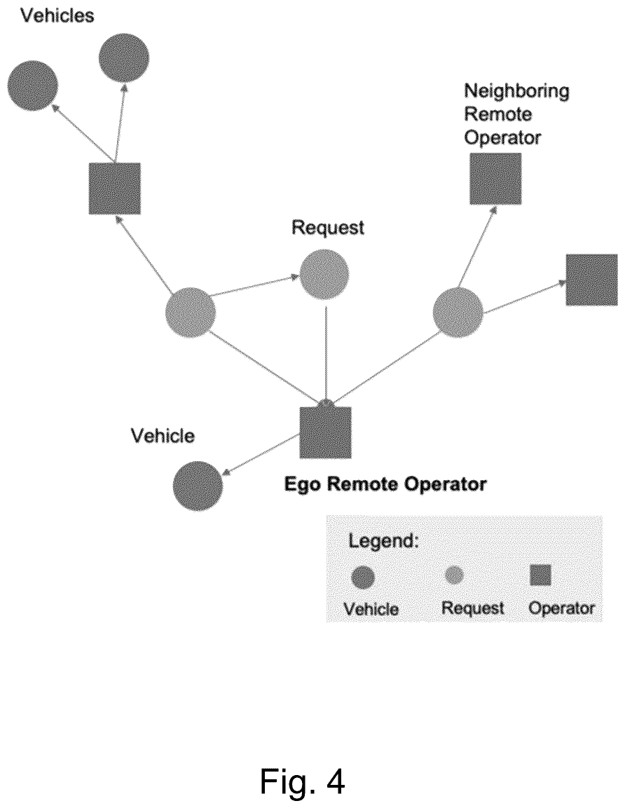

The graph may comprise vertices and edges, as illustrated in FIG. 4. The vertices of the graph may comprise a set of valid help requests, a set of remote operators (e.g., that are within a threshold distance of the vehicle identified in the real-time characteristic of the vehicle corresponding with each of the locations of the decentralized system), and a set of vehicles. The edges of the graph may comprise a request-to-request edge, a request-to-remote operator edge, and a remote operator-to-vehicle edge. The graph may be input to each distributed, machine learning agent.

In some examples, the actions of the remote operator can be viewed as a set of tasks in a hierarchy. Each remote operator can be instructed to pick up, drop off, or rebalance calls based on the current assignment and the number of available remote operators and vehicles. For pick-up, there may be additional decision-making to choose which help request to assign to which remote operator; for rebalancing (handover), there may be a specific target zone location associated with location of the remote operator (e.g., geographic knowledge).

The input state features of the graph may be split by vertices and edges. The vertices may comprise help requests, remote operators, and vehicles. The help request values may comprise, for example, the origin, destination, context, wait duration, wait delay tolerance, travel delay tolerance, repeat remote operator, senior friendly, teen friendly, situational/location experience, emergency, payment types, and language preference values. The remote operator values may comprise, for example, a unique vehicle code (e.g., ego vehicle), situational/location experience, operational experience, language, skill, senior friendly, teen friendly, temperament, emergency experience, and driver/non-driver values. The vehicle values may comprise, for example, origin, destination, context, wait duration, current travel time, shortest travel duration, scheduled travel duration, wait delay tolerance, travel delay tolerance, stress level of caller, health, and age values.

When the edges of the graph are determined, the edges between the help request and remote operator may be weighted based on the assignment or non-assignment of the help request. For example, the help requests that are not assigned may be given a higher priority than the help requests that are assigned, causing the help requests that are not assigned may be assigned first. The next highest priority may be given to the help requests that are assigned but need reassignment when the remote operator is actively helping another driver and vehicle situation.

Remote operator action suggestion engine 324 is configured to determine and provide a remote operator action for the remote operator or the second remote operator. For example, the action suggestion may instruct the remote operator to provide updated driving directions for the driver, start a conversation with the driver (e.g., to wake up the driver if they are sleepy or calm down the driver during a high stress situation), or take over control of driving the vehicle (e.g., during an emergency event). In some examples, the action suggestion may instruct the remote operator to perform an action (e.g., take a break, reassign a vehicle to a second remote operator, etc.).

Remote operator action suggestion engine 324 may identify various actions. For example, the action may comprise an assignment of the remote operator to a set of help requests that are nearby in geographic location where the remote operator is located. The action may comprise guiding a particular vehicle toward an end of a trip location according to a best ending trip sequence (e.g., of directions). The action may comprise instruction the remote operator to hand over handling of the help request to a second operator due to latency or unmet needs of the driver (e.g., as identified in the driver profile or real-time tracking of the conversation).

In some examples, remote operator action suggestion engine 324 is configured to track the effectiveness rate of the remote operator or the second remote operator and perform an action in response to the determined effectiveness. For example, remote operator action suggestion engine 324 may determine an effectiveness rate of the remote operator or the second remote operator. When the effectiveness rate decreases in excess of a threshold value for the vehicle, remote operator action suggestion engine 324 may reassign the vehicle from the cluster of vehicles from the remote operator and instruct the remote operator to take a break as a remote operator action.

Network latency engine 326 is configured to determine a latency of a network between the system and the vehicle based on the latency, and adjust a remote operator action. This network latency value may vary for each remote operator location and vehicle location in the decentralized system, since the communication paths between the plurality of locations can vary greatly and without a single remote operator location performing the analysis. For example, network latency engine 326 may ping or otherwise communicate the vehicle or server to identify the communication efficiency between the remote operator and the vehicle. When the latency determined from the communication is below a threshold value, the action may be adjusted to account for the latency. As illustrative examples, the action may instruct the remote operator to tell the driver to operate the vehicle on their own (e.g., because the remote operator's instructions for the vehicle are not received in a reasonable amount of time), or the action may instruct the vehicle to turn on emergency blinkers and safely park the car (e.g., until the network latency values improve in excess of the threshold value).

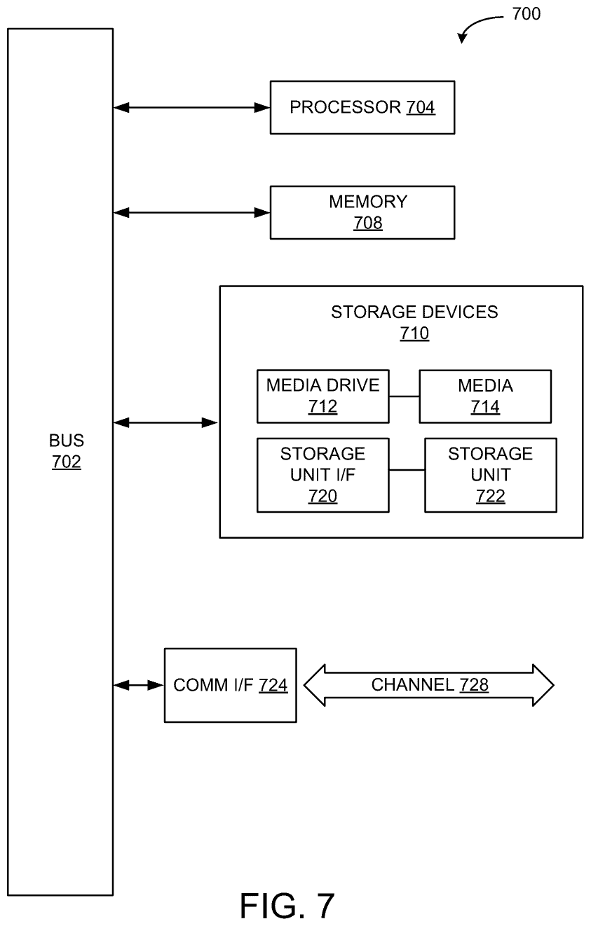

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up vehicle 200 of FIG. 1 or matching system 300 of FIG. 3. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer system for programmatically determining a remote operator of a vehicle that operates in autonomous or semi-autonomous modes, the computer system comprising:
a memory; and
one or more processors that are configured to execute machine readable instructions stored in the memory to:
determine a driver profile associated with the vehicle, wherein the driver profile comprises propensities or preferences of a driver of the vehicle;
determine a real-time characteristic of the vehicle;
when a characteristic of a remote operator profile of a remote operator matches a characteristic of the driver profile and the real-time characteristic of the vehicle, add the vehicle to a cluster of vehicles for the remote operator; and
upon receiving a help request for the vehicle, reassign a second vehicle from the cluster to a second remote operator in accordance with a recalculation priority of the second remote operator and the second vehicle.

2. The system of claim 1, wherein the help request for the vehicle is associated with a manually-activated switch at the vehicle.

3. The system of claim 1, wherein the help request for the vehicle is associated with an automated request determined by the vehicle.

4. The system of claim 1, wherein the real-time characteristics of the vehicle comprise a geographic location of the vehicle and the remote operator profile comprises a location characteristic with knowledge of the geographic location.

5. The system of claim 1, wherein the real-time characteristic of the vehicle comprise an emergency event of the vehicle and the remote operator profile comprises a mitigation characteristic corresponding with the emergency event.

6. The system of claim 1, wherein the remote operator profile comprises a speech characteristic that matches a preference characteristic in the driver profile of the vehicle.

7. The system of claim 1, wherein the remote operator profile comprises a mitigation characteristic that matches a propensity characteristic in the driver profile of the vehicle.

8. The system of claim 1, wherein the remote operator profile comprises a location characteristic that matches a propensity characteristic in the driver profile of the vehicle.

9. The system of claim 1, wherein the help request is generated by the remote operator manually identifying an emergency event.

10. The system of claim 1, wherein the help request is generated by an automated process determining an emergency event.

11. The system of claim 1, wherein the recalculation priority of the second remote operator and the second vehicle is implemented by a graph neural network (GNN) model.

12. The system of claim 1, wherein the one or more processors are configured to execute the machine readable instructions stored in the memory further to:
determine a remote operator action for the remote operator or the second remote operator; and
provide the remote operator action to the remote operator or the second remote operator.

13. The system of claim 1, wherein the one or more processors are configured to execute the machine readable instructions stored in the memory further to:
determine an effectiveness rate of the remote operator or the second remote operator; and
when the effectiveness rate decreases in excess of a threshold value for the vehicle, reassign the vehicle from the cluster of vehicles from the remote operator and instruct the remote operator to take a break as a remote operator action.

14. The system of claim 1, wherein the one or more processors are configured to execute the machine readable instructions stored in the memory further to:
receive audio data associated with the driver of the vehicle;
apply a Fourier transform to a frequency domain of the audio data;
compare the transformed audio data with sinusoids of various frequencies of predetermined stress levels to obtain a magnitude coefficient;
compare the magnitude coefficient to a coefficient threshold;
when the transformed audio data matches one of the sinusoids of various frequencies of predetermined stress levels, identify a stress level from the predetermined stress levels; and
adjust a remote operator action to address the stress level.

15. The system of claim 1, wherein the one or more processors are configured to execute the machine readable instructions stored in the memory further to:
determine a latency of a network between the system and the vehicle; and
based on the latency, adjust a remote operator action.

16. A method for programmatically determining a remote operator of a vehicle that operates in autonomous or semi-autonomous modes, the method comprising:
determining a driver profile associated with the vehicle, wherein the driver profile comprises propensities or preferences of a driver of the vehicle;
determining a real-time characteristic of the vehicle;
when a characteristic of a remote operator profile of a remote operator matches a characteristic of the driver profile and the real-time characteristic of the vehicle, adding the vehicle to a cluster of vehicles for the remote operator; and
upon receiving a help request for the vehicle, reassigning a second vehicle from the cluster to a second remote operator in accordance with a recalculation priority of the second remote operator and the second vehicle.

17. The method of claim 16, wherein the help request for the vehicle is associated with a manually-activated switch at the vehicle.

18. The method of claim 16, wherein the help request for the vehicle is associated with an automated request determined by the vehicle.

19. The method of claim 16, wherein the real-time characteristics of the vehicle comprise a geographic location of the vehicle and the remote operator profile comprises a location characteristic with knowledge of the geographic location.

20. The method of claim 16, wherein the real-time characteristic of the vehicle comprise an emergency event of the vehicle and the remote operator profile comprises a mitigation characteristic corresponding with the emergency event.
